(19) United States
(12) Patent Application Publication
(10) Pub. No.: US 2002/0059790 A1
(43) Pub. Date: May 23, 2002

(54) Combined baler and rake apparatus

(76) Inventor: Mark W. Paulsen, Elk Horn, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/037,113

(22) Filed: Oct. 22, 2001

Related U.S. Application Data
(63) Continuation of application No. 09/173,880, filed on Oct. 16, 1998, now abandoned.
(60) Provisional application No. 60/063,064, filed on Oct. 27, 1997.

(51) Int. Cl. A01D 78/14

(52) U.S. Cl. 56/377

(57) ABSTRACT

An apparatus and method for combined raking and baling of either baleable crops or after-harvest stalks, stubble, and trash. A rake is installed in front of the operating throat of a baler. The rake channels materials into the baler throat in the same pass over the field to effectively improve on the baling efficiency and/or extend the area of ground coverage for the implement.

### BACKGROUND OF THE INVENTION

1. Field of the Invention

The present invention relates to the baling of agricultural plants and/or trash or stubble of agricultural plants, and in particular, to an apparatus and method for improved capture and feeding of materials to be baled into a baler.

2. Problems in the Art

The task of baling has always been hard and time-consuming work. There has been a constant search for improved efficiency, including manpower, costs, time, fuel, machinery, and other aspects associated with baling.

Many advances have been made over the years. For example, mechanized baling has evolved to where round balers have a substantial part of the market. Round balers allow one person to gather, crops, or trash and create a large bale that is left in the field. That bale can later be transported for use.

However, prior to baling, there is generally the need to mow a live crop or existing stalks or stubble and then rake that material into wind-rows. The baler then picks up each wind-row and bales it. However, this requires at least two passes through the field, with associated fuel, machinery, and manpower costs.

In some circumstances, usually quite limited, a round baler could be driven through the field without mowing or raking. However, round balers are generally limited in their operating width, which is essentially equivalent to the width of the bales it creates. In the industry, the round balers are generally five foot wide. Therefore, the baler itself has approximately a five-foot throat. This generally may only allow two or three rows of the crop or five-foot widths of the crop, mowed and rake crop, or trash to be covered per pass. It would be extremely inefficient and time-consuming to go through a field two rows at a time, or just in five foot strips at a time.

Therefore, one part of the efficiency of round balers is how much material can be put into the baler, and how wide a reach per pass of the field the baler can handle.

With some crops, such as field corn, it is beneficial to remove remaining stalks, stubble and trash, or at least remove some of the same. Furthermore, it is becoming increasing invaluable to utilize the remaining after-harvest plant material for things such as bedding for livestock, feed for livestock, and even non-agricultural products. For example old corn stalks and leaves are now used in a process of manufacturing certain types of plastics.

However, of course, the economies of taking the time and machinery to process the remains of the after-harvest, must be carefully balanced with the amount of benefit that can be obtained from the same.

One option to get rid of the remains of the after-harvest is to let livestock into the field to eat as much as possible. Another option is to run an implement through the field to chop up the remains so they will degrade faster before next year's planting season. A still further option is to bale the material, then either dispose of it or use it for other things such as described previously.

However, similar problems regarding efficiencies described previously exist when attempting to bale the remains of after-harvest. One can make a pass through to cut and/or rake the remains, followed by a second pass through to bale the remains. As described previously, one could also just run a baler through the field to try to pick up as much as possible. However, the width of the baler, as far as its processing capability, is limited making it too costly in the amount of time and fuel to process the same. Also, the baler itself may not pick up materials merely scattered on the ground or stalks that are still anchored in the ground.

Also, it should be understood that if two passes are made (one to rake the material up, the second to bale it), one may rake up too much material relative to the number of bales one needs or can afford to make. For example, if one rakes ten acres of material into wind rows, but only six acres of material is needed at the time to make the number of bales desired, the raking of the additional four acres is wasted time and resources. If so, the raked, unbaled material must be removed before the next year's planting. Again, the operation takes two passes.

There are, of course, many types of agricultural implements that exist with regard to work in field crops. Round balers have been mentioned. Some rounder balers include what are called tucker or converging wheels at opposite sides of the front throat of the baler. The tucker wheels are relatively small and may have tines or teeth. They are angled to try to tuck into the throat of the baler any materials that are at the margins of the throat. They help try to even out the volume of material as it enters the baler so that the big round bales are as even as possible across their width. The tucker wheels generally do not extend much outside the width of the operating throat of the baler. It should be further mentioned that it is the experience of the applicant that such wheels are not useful with regard to baling, for example, after-harvest corn stalks, trash and stubble. They can be either ineffective or even detrimental by being plugged up by residues that exist with regard to corn stalks, for instance.

All sorts of different types of rakes exist. For example, there are rakes having rotating, circular wheels comprised of the a number of tines. The wheels run across the ground. The wheels are positioned in such a way that moved materials are channeled into a wind-row for baling. A substantial width of the field can then be concentrated into a wind-row capable of being processed by the baler. Some of these rakes can either be linear, in other words, comprised of spaced-apart but overlapping wheels along a linear frame. Some exist that are v-shaped whereby the rake funnels material from a wide piece of ground into a center area that is no wider than a baler throat or intake. However, such rakes require at least two passes of the field (raking then baling), again which is costly.

There are some known implements that combine a shredder device directly in front of a baler. While this assists in processing stubble, stalks and trash for a baler, it does not increase the working width of the baler. However, again, the baler may not effectively and efficiently pick up the shredded material. Also, shredders or choppers are mechanically driven, require more power and thus energy, and require more maintenance.

Some devices are known which place rakes on the tractor to try to either gather more material or gather material from a width larger than the baler. However, a deficiency of such a system is that the rakes are attached to the tractor. There is not a self-contained rake/baler. Furthermore, it is difficult to allow the tractor to be used for other functions when such rakes are mounted thereon. Also, the rakes can kick up dirt, dust, and debris that can affect the operation of the tractor.

Therefore, there is a real need in the art for an improvement regarding baling of either field crops such as hay, straw, and the like, or baling after-harvest stalks, trash, and stubble. It is therefore a principal object of the invention to provide a apparatus and method which improves upon or solves the problems and deficiencies in the art.

Further objects, features, and advantages of the invention include an apparatus and method which:

1. Allow one pass, one worker operation.

2. Allow baling of only as much material as desired.

3. Can be used for a variety of different crops or after-harvest materials.

4. Increase efficiencies of balers by increasing the operating width of the baler.

5. Save time.

6. Save money.

7. Are non-complex.

8. Are durable and economical.

9. Eliminate multiple vehicles operating simultaneously in a given field.

10. Are flexible and adjustable for different applications.

These and other objects, features and advantages of the present invention will be come more apparent with reference to the accompanying specification and claims.

### SUMMARY OF THE INVENTION

The present invention comprises an apparatus and method for increasing the efficiency of baling by one implement, in one pass of the field. The apparatus includes a rake on a frame that can be installed in front of the throat of the baler. The rake extends outside the operating width of the baler to increase the effective width of the implement during use. The rake gathers material from wider than the width of the baler for baling. By its attachment between a motive member, such as a tractor, and the baler, the rake/baler is self-contained and can be separated from the motive means or tractor so that the tractor can easily be used for other functions. The apparatus can also include the combination of the rake with a baler, and the rake with the baler and the tractor.

The method according to the invention comprises, in one pass through a field, raking material from the field behind the motive member, such as a tractor, in a manner that gathers it in front of the baler from a wider swathe than a baler alone and concentrates it to a size useable for the throat of a baler and then baling the material to increase the efficiency of the baling process.

### BRIEF DESCRIPTION OF THE DRAWINGS

FIG. 1 is a top plan view of an apparatus according to the present invention hitched to a tractor and illustrating its general operating principals in a crop field.

FIG. 2 is a partial, enlarged elevational view taken along line 2-2 of FIG. 1.

FIG. 3 is a partial, enlarged, top plan view taken along lines 3-3 of FIG. 2.

FIG. 4 is a still further enlarged, partial, elevational view taken along line 4-4 of FIG. 3.

FIG. 5 is a partially exploded, perspective view of the mainframe and part of one wing of the rake portion of the implement of FIG. 1.

FIG. 6 is similar to FIG. 2 but shows an alternative embodiment of the attachment of the rake wheels to the framework supported them.

FIG. 7 is a diagrammatic depiction of the pivoting action of the embodiment of FIG. 6.

FIGS. 8 and 9 are schematic views of the operation of the embodiment of FIG. 6.

### DETAILED DESCRIPTION OF THE PREFERRED EMBODIMENT

In order to provide a better understanding of the invention, a description of one possible embodiment of the invention will now be described in detail. Frequent reference will be taken to the accompanying drawings. Reference numbers will be used to indicate certain parts and locations in the drawings. The same reference numbers will be used to indicate the same parts and locations throughout the drawings unless otherwise indicated.

The preferred embodiment will be described with respect to a Vermeer 605K round baler, such as are known in the art. It will also be described relative to after-harvest stock, stubble, and trash from a corn field. It is to be understood, however, that the invention can be utilized for different stalks, stubble and/or trash or baling such things as hay, straw, and the like. It can also be used with other similar balers which have an intake or pick up and process mowed plant material or stubble and trash. Other uses are contemplated as will be within the understanding and skill of those skilled in the art.

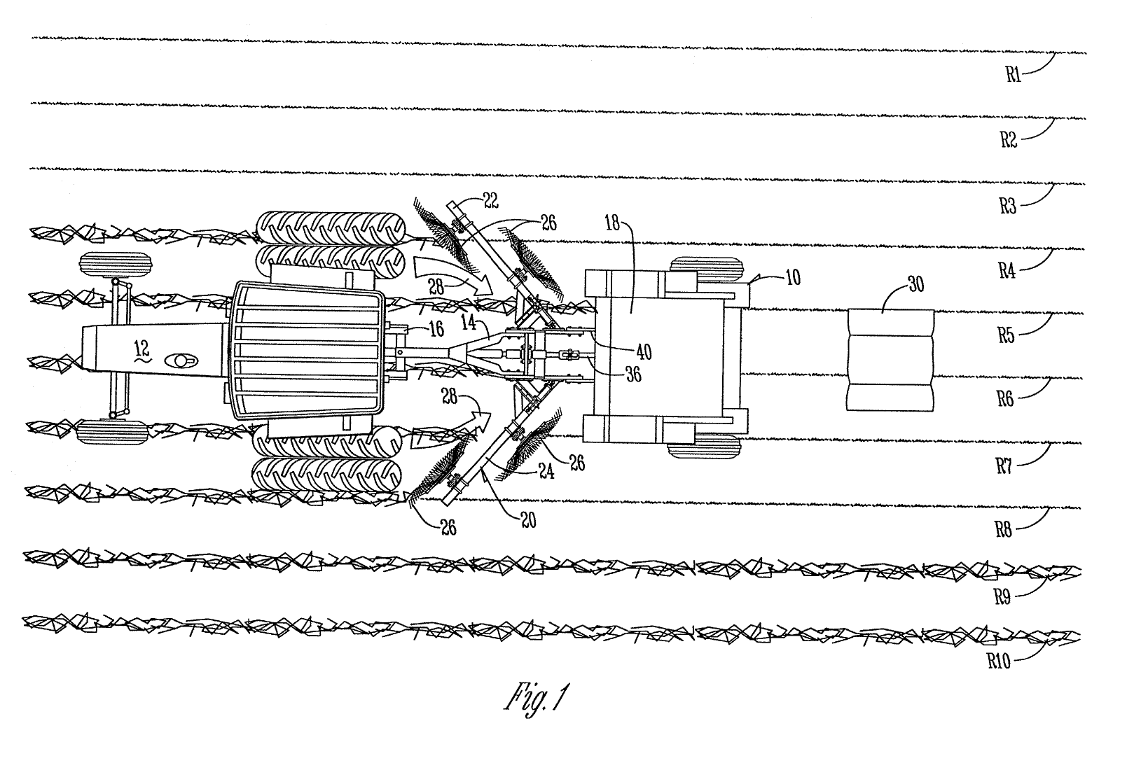

By referring to FIG. 1, a preferred embodiment of the invention is illustrated. A rake/baler 10 is connected to tractor 12 by hitch 14 which is connected to tractor hitch 16. A A Vermeer 605K round baler 18 is at the rear of apparatus 10. Intermediate of hitch 14 and baler 18 is rake section 20.

As is further shown in FIG. 1, device 10 is running through a cornfield after the corn has been harvested. Corn stalks and stubble exist in rows R1-R10. Trash and other after-harvest materials can exist along rows R1-R10 or in between rows R1-R10, such as is well known in the art. Baler 18 has an operating width of approximately five feet at throat 19, which is approximately the entire width of baler 18. As can be seen in FIG. 1, rake 20 includes two wing-arms 22 and 24 that extend outwardly and forwardly. Rake wheels 26 are staggered on opposite sides of each wing 22 and 24, but overlap slightly. As indicated at arrows 28, rake 20 therefore pulls into throat 19 of baler 18 stalks, stubble, and trash from at least crop rows R3-R7 (five rows in total) which can be processed to create a bale 30 when enough material has been collected in baler 18.

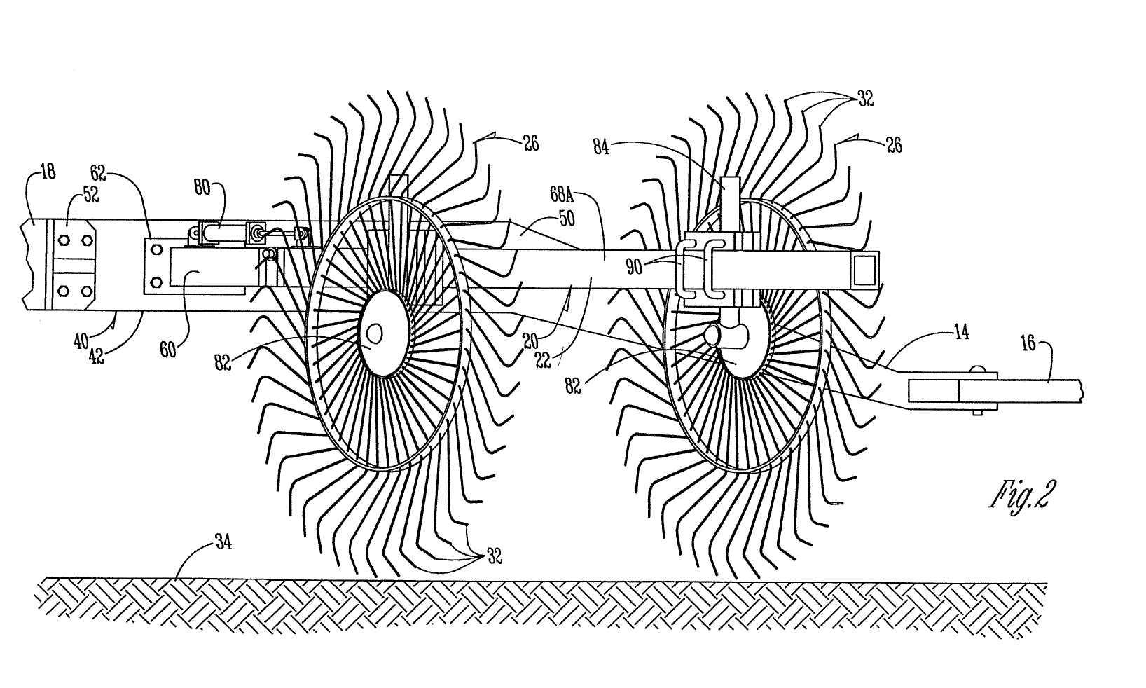

It is further pointed out that tractor 12 can be driven so that its front wheels travel over rows R3 and R7 to flatten those rows. As is know in the art and as can be further appreciated by viewing FIG. 2, rake wheels 26 (approx. 4 feet in diameter) are standard, off-the-shelf John Day rake wheels and hubs. The tines 32 of rake wheels 26 contact the ground 34 of the field and roll along the ground. The angular orientation (approx. 45°) with regard to the direction of travel, also allows tines 32 to pick up and channel rearwardly stalks, stubble, and trash from the field. Although baler 18 is driven by PTO shaft 36 of tractor 12, rake 20 does not require any drive mechanism and therefore does not contribute materially to any need power thus fuel for its operation.

FIG. 1 also illustrates that without rake 20, baler 18 at best could cover perhaps 2 or 3 rows R4 to R6 instead of the at least five rows, R3 to R7. Therefore, the area processed per pass is approximately doubled over just using baler 18.

For example, wing members 22 and 24 of rake 20 are approximately six foot in length. Rake wheels 26 are approximately 48 inches in diameter. Rake 20 and baler throat 19 therefore span over twelve and a half feet of the field as opposed to the approximately five-foot width of baler 18. Thus, the operating width is in fact over double that of baler 18 alone.

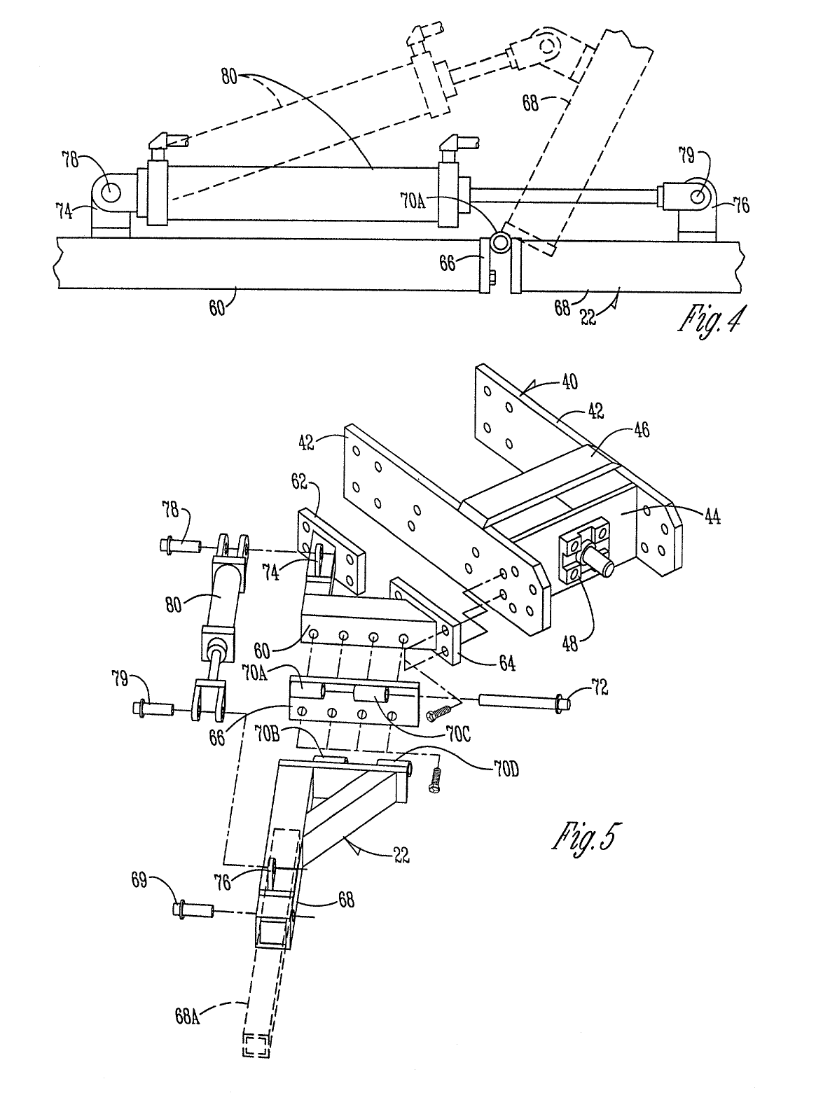

By referring also to FIGS. 2-5, the construction of apparatus 10 can be further understood. Hitch 14 is simply the hitch normally associated with baler 18 and thus is available with baler 18. Rake 20 is installed between hitch 14 and baler 18. As shown in FIG. 5, a frame 40 is comprised of two 10 inch tall by 3/4 inch wide by approximately 3-foot long rails 42 held parallel by cross-bar 44 (also 10 inch wide by 3/4 inch thick steel plate and approximately 21 inches wide). A further cross-support 46 of 6 inch by 3/4 inch by approximately 21 inches steel plate is also welded between rails 42. A bearing block 48 exists in cross-bar 44. As can be seen in FIG. 3, bearing block 48 cooperates with various sections of PTO shaft 36 to transfer rotational power take-off (PTO) power from tractor 12 to baler 18. The precise connections are shown in FIG. 3 but could vary according to need and are within the skill of those skilled in the art to create.

FIG. 3 also shows that arms 50 of hitch 14 are bolted to the front of rails 42. Flanges 52, originally attached to baler 18, are bolted to the rear of rails 42. Thus, frame 40, approximately 3-foot long, extends the length of the original baler 18 approximately 3 feet, but allows an extension of the PTO shaft 36 as mentioned.

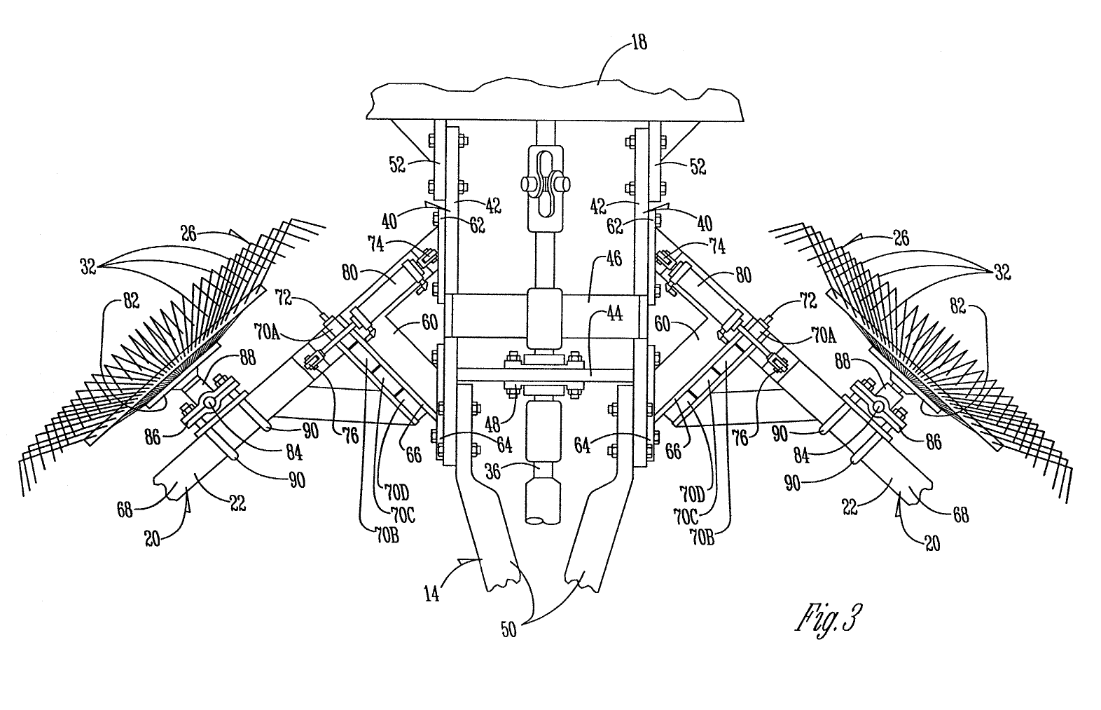

As previously mentioned, wing-arms 22 and 24 extend forwardly and outwardly from frame 40 (see in particular FIG. 3). FIG. 5 shows that a v-shaped component 60, having feet 62 and 64 at opposite ends, is bolted through apertures in rail 42 to both side of frame 40. A plate 66 is bolted to the forward-most facing side of v-shaped member 60. An arm 68 is then attached to plate 66 by aligning tubes 70, which are welded as shown in FIG. 5, in spaced-apart locations on plate 66 and arm 68, in a manner so that when aligned, pivot pin 72 can be placed through all of tubes 70. The pin 72 can then be removably secured in position by a cotter key or other means well within the skill of those skilled in the art. Therefore, tubes 70 and pin 72 essentially act like a piano hinge which would allow arm 68 to pivot upwardly. An upwardly extending ear 74 is welded on top of v-shaped member 60. A similar ear 76 is welded on top of arm 68. A hydraulic cylinder 80 is removably connected by pins 78 and 79 to ears 74 and 76. Actuation of cylinder 80 would therefore lift or pivot arm 68 upwardly about hinge 70/72 when desired (see FIG. 4).

By referring to FIGS. 3 and 4 it can be seen that rake wheel hubs 82 are rotatably connected to a vertical rod 84 that is adjustable in block halves 86 and 88, which are secured to arm 68 by u-bolts 90. Such an arrangement allows the height of rake wheels 26 to be adjusted by loosening the bolts in block halves 86 and 88 and adjusting vertical rod 84 relative to arm 68. Also, u-bolts 90 can be loosened and moved along arm 68 to adjust the placement of rake wheels 26 along wings 22 and 24.

The previous description applies to both wings 22 and 24, as can easily be appreciated. Each is basically a mirror image of the other.

As can be seen in the figures, the front-most rake wheels are connected to the inside of wings of 22 and 24 whereas the rearward-most rake wheels 26 are connected to the outside. This allows some overlap between the reach of each rake wheels 26 on each side of rake 20 (see FIG. 1) for continuous coverage across the ground.

It is furthermore to be understood that, if desired, each arm 68 of each wing 22 and 24 could be comprised of two pieces. As shown in FIG. 5, an extension piece 68A could be of square, tubular steel that would slide within the square tube 68. It could be secured in place by pin 69 or other means. This would allow, for example, the front-most rake wheels 26 to be removed if needed and the device operated with just rear rake wheels 26 (sometimes preferred if using device 10 for conventional hay baling, for example). Alternatively, arm 68 could be all one piece.

In operation, rake 20 is installed between baler 18 and hitch 14 as previously described. The height and position (and number) of rake wheels 26 is then selected. One method of doing so is to hook apparatus 10 to tractor 12 and drive it onto a level surface such as a cement slab. The height of rake wheels 26 can be adjusted as described as can their spacing along wings 22 and 24. Depending on what use is desired, the number of rake wheels 26 can be selected. The number can possibly exceed four but limitations do exist with respect to wings 22 and 24 getting too wide. If they are too long or wide, they may cause a conflict with the rear tires of tractor 12, at least when turning. In the preferred embodiment, wings 22 and 24 are approximately 45° relative to the front-to-back axis of apparatus 10. Other angles are possible, but 45° has been selected to provide enough action for channeling material into throat 19 of baler 18 with a minimum amount of rolling resistance and possibility of breakage of rake wheels 26.

Once adjusted, apparatus 10 can be transported to a field without operating rake wheels 26 by actuating cylinders 80. When actuated, arms 68 would pivot upwardly raising rake wheels 26 off the ground.

When arriving at the field, as with any other row-crop activity or field-working activity, the operator begins coverage of the field. In this instance the tractor is driven so that the front tires are on rows R3 and R6. The device then rakes in stalks, stubble, and trash from rows R3-R7 until enough is accumulated to make a bale 30. In the next pass of the field, the operator moves over so that the next five rows are processed and continues successively in that manner until the number of bales 30 desired by the operator or the owner of the field are created. No excess stalks, stubble, and trash is raked, which would then have to be subsequently dealt with. The rake wheels 26 passively driven, pick up and channel material to baler 18.

When completed, cylinders are actuated to lift rake wheels 26 off the ground and implement 10 is driven off the field. It can then be detached from tractor 12. Being a self-contained rake/baler 10, tractor 12 can then be used for other purposes without having the structure associated with rake/baler 10 connected to the tractor 12 or having to remove any such structure from tractor 12. Self-contained unit 10 is thus ready to be used again.

It is to be understood that the foregoing preferred embodiment is set forth for exemplary purposes only and not by way of limitation of the invention. Obvious variations within the skill of those skilled in the art are included within the invention.

For example, instead of having two cylinders 80 raising each wing 22 and 24, a single cylinder could be placed centered on frame 40. The cylinder could extend vertically so that when its piston extends, its outer end would extend upwardly. Connections such as a chain could be made to wings 22 and 24 so that when the Cylinder is extended upwardly, wings 22 and 24 would pivot upwardly.

Different types of pivots and connections between parts could be made such as is within the skill of those skilled in the art.

The preferred embodiment is made predominantly of steel plate and tubing. Other materials may be possible.

An alternative embodiment of the invention is shown at FIGS. 6-9. This embodiment, referred to generally at reference numeral 100, is similar in most respects to embodiment 10 except for the following.

As shown in FIG. 6, instead of straight tubes or wing arms extending from arm 68 (see FIGS. 2 and 5), an L-shaped extension 102 is mateable into arm 68. The proximal section 104 of extension 102 (e.g. 30″ long) slides into extension 102 and can be secured there by bolts or other means. The distal section 106 (e.g. 8″ in long) extends upwardly and pivotally supports beam 108 by a pivot pin 110 or other means. Rake wheels 26 are adjustably mounted to beam 108 by vertical rods 84, as described with regard to embodiment 10.

FIG. 6 does show some specific structure that will now be described. One way arm 108 can pivot relative to the support structure of arm 102 is by welding a tubular member 107 to the top of arm section 106 of arm 102. Tube 107 would have opposite open ends and would be placed transverse or perpendicular to the longitudinal axis of arm 108. Plates 109 would be welded or otherwise secured to opposite sides of arm 108 (preferably at or linear the center of its length). Apertures would be formed in alignment on plates 109 and 111 underneath arm 108. Plates 109 and 111 would be spaced so that they are slightly wider than the length of tube 107 and when the apertures and plates 109 and 111 are aligned with the ends of tube 107 a pivot pin 113 could be inserted there through and secured in position by any number of means, including cotter keys 115 and 117. The bottom of arm 108 would be spaced apart from the top of tube 107 so that all the weight of arm 108 and any attachments is borne by pivot pin 113 and the associated structure with that pivot axis. Other methods of pivotal attachment of arm 108 to the remainder of the implement are possible.

FIG. 6 also shows an alternative embodiment for attaching rakes to arm 108 and allowing their vertical adjustment. As shown in FIG. 6, a connection 121 could be welded to the side of arm 108. A tubular sleeve 123 could in turn be welded or otherwise secured to connection 121 so that its opposite open ends are up and down generally. Sleeve 123 is split along its length. Flanges 125 and 127 extend on opposite sides of the split and have two sets of aligned apertures. The posts or —vertical support 84 for a rake is then inserted inside and through sleeve 123. Bolts are positioned through the two sets of aligned apertures and are tightened down with nuts so that sleeve 123 squeezes or clamps posts 84 and a desired vertical position. Other ways of attaching the rakes to the arm 108 are possible.

Another feature shown in FIG. 6 that is optional yet can be used advantageously is to connect at least one end of arm 108 to frame of the implement. As shown in FIG. 6, this can be accomplished by chain 137 connected at one end to a loop or hook welded or otherwise connected to one end of arm 108 and extending then to plate 133. Plate 133 can be welded to the arm 102 (in this case a wing 22 or 24). The other end of chain 137 could have a hook and could be selectively positioned in any plurality of apertures 135 along plate 133 to adjust the amount of separation between the end of arm 108 connected to chain 137 and wing 22 or 24 when chain 137 is fully extended. This arrangement would prevent the opposite end of arm 108 from pivoting too far down which could create complications or damage.

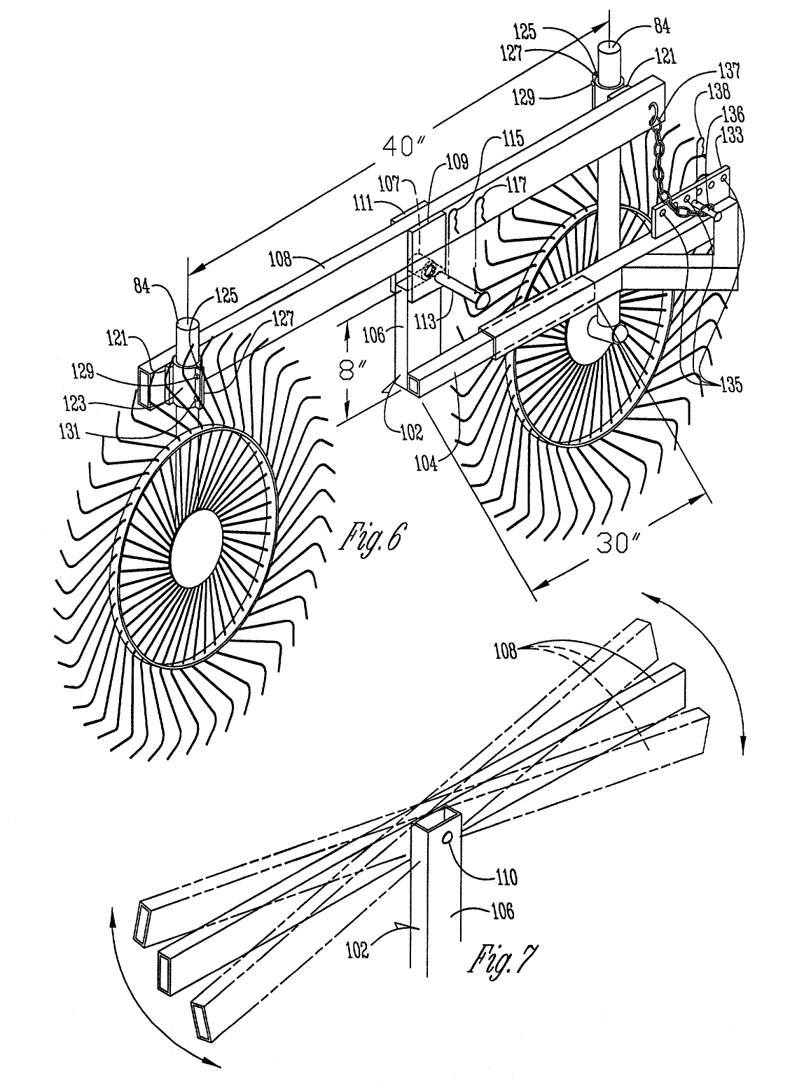

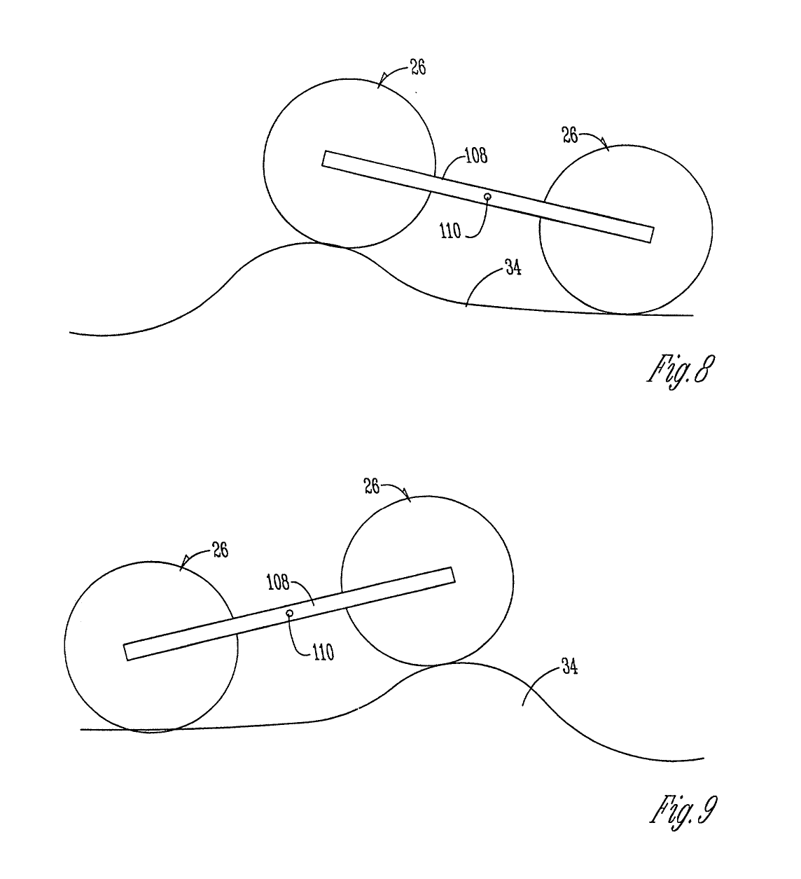

FIG. 7 illustrates diagrammatically how beam 108 pivots about pivot pin 100. FIGS. 8 and 9 show the practical advantage of this arrangement. When a front rake wheel 26 experiences a rise in the terrain, or a rock or other object (FIG. 8), it will follow it and remain in contact. At the same time, this will cause beam 108 to pivot and allows the following rake wheel 26 to stay in contact with the ground. When the forward wheel 26 passes over the bump or object (FIG. 9), and the rear wheel 26 reaches it, beam 108 will pivot the other way and continue to allow both wheels 26 to maintain contact with the ground.

This arrangement deters one of the wheels on a side of the device to lift off the ground if the other wheel must travel over a raised item, and allows both wheels to better follow the ground during use.

It is to be understood that the tucker or converging wheels found on some round balers could, if desired, be removed from the baler if the rake 20 is used. Sometimes the tucker or converging wheels get plugged up or otherwise do not materially help the process.

Still further, it is to be understood that while the preferred embodiment attaches rake 20 directly between the tractor and baler 18, it is possible to have an implement or structure between the tractor and rake 20 and/or between rake 20 and baler 18. For example, a shredder (as previously discussed) might be placed between rake 20 and baler 18 and shred the stalk and stubble collected by rake 20 prior to entry to baler 18. Possibly, a shredder or other implement could be placed between the tractor and rake 20. In any of these cases, rake 20, baler 18 and any additional implements or structures are behind the tractor.

Also, it is to be understood that the size and operating width of rake 20 can vary by design. In the preferred embodiment, the operating width of rake 20 is over twice the width of the throat of baler 18, and can be on the order of ten to fourteen feet wide. Fourteen feet width has been found to create bales of relatively consistent diameter across their width. However, on the order of fifteen foot width can also be used. Even wider widths are possible, but it has been found that if much wider, the collected stalks and stubble tend to congregate at the opposite sides of the throat of the baler and thus create bales with larger diameters at opposite sides, which is usually undesirable and which could create enhanced wear and tear on the baler.

What is claimed is:

1. A rake attachment for a large baler comprising:
a frame member having a front end and a rear end;
the front including a connection member capable of connection between a motive means and a rake member;
the rear end including a connection member capable of connection between the rake member and a large baler; and
a rake member extending transversely from the frame member.

2. The rake attachment of claim 1 wherein the frame member includes a passage between front and rear for a PTO shaft.

3. The rake attachment of claim 2 wherein the frame includes bearing members along the passage.

4. The rake attachment of claim 1 wherein the connection member on the front of the frame comprises a hitch.

5. The rake attachment of claim 4 wherein the connection member on the front comprises a hitch from a large bale baler.

6. The rake attachment of claim 1 wherein the connection member on the rear comprises frame pieces and bolts.

7. The rake attachment of claim 6 wherein the connection member on the rear comprises frame pieces which match up with a large bale baler hitch connection.

8. The rake attachment of claim 1 wherein the rake comprises a rake wheel rotatably mounted on an arm attached to the frame member.

9. The rake attachment of claim 8 wherein the arm member extends forwardly at an angle from the frame.

10. The rake attachment of claim 9 wherein the angle is in the range of 20° to 60°.

11. The rake attachment of claim 10 wherein the angle is in the range of 35° to 50°.

12. The rake attachment of claim 11 wherein the angle is approximately 45°.

13. The rake attachment of claim 9 further comprising first and second arms extending from opposite sides of the frame.

14. The rake attachment of claim 13 comprising a plurality of rake wheels on each arm.

15. The rake attachment of claim 14 wherein the wheels are spaced apart but overlapped.

16. The rake attachment of claim 1 further comprising in combination a large bale baler having a pick-up width, wherein the raking width is greater than the pick-up width.

17. The rake attachment of claim 16 wherein the raking width is substantially greater than the pick-up width.

18. The rake attachment of claim 1 wherein the rake member comprises two arms extending out and forwardly from the frame and a plurality of rake wheels on each arm having planes of rotations generally aligned with the arms.

19. The rake attachment of claim 18 wherein the rake wheels are spaced apart but overlapping.

20. The rake attachment of claim 1 further comprising connections between each arm and the frame to raise and lower a rake means.

21. The rake attachment of claim 1 further comprising adjustable mounting means for the rake wheels to the arms for adjustability in width of the rake means and vertical height of the rake means.

22. The rake attachment of claim 1 further comprising a pivot means between the frame and the rake wheels to allow the rake wheels to maintain contact with the terrain over variations in the train.

23. The rake attachment of claim 8 wherein the arm includes a section that can pivot over a range around a pivot pin, a rake wheel being attached on either side of the pivot pin.

24. The rake attachment of claim 1 further comprising in combination a baler, the baler attached to the connection member at the rear of the frame work; the baler having a pick-up width which is less than the width between rake wheels.

25. In combination a large bale baler and a rake member comprising:
a large bale baler having an intake with and a connection member;
a hitch adaptable for connection to a tractor;
an intermediate framework attachable between the hitch and the connection on the large bale baler;
at least one arm attached at one end to the intermediate framework and extending from the framework;
at least one raking member attached to the arm and transversely wider than the intake width of the baler.

26. The combination of claim 25 further comprising an implement connected between the rake member and the baler and/or between the tractor and the rake member.

27. The combination of claim 26 wherein the implement is a shredder.

28. The combination of claim 25 further comprising a tractor which is operatively connected in front of the rake member and baler.

29. A method of baling comprising:
in a single pass through a field, baling material through a pick-up width of a baler; while at the same time raking, from behind a motive means, material from substantially wider than the pick-up width of the baler.

30. The method of claim 29 wherein substantially wider means is at least 50% wider than the pickup width.
